(19) United States
(12) Patent Application Publication
(10) Pub. No.: US 2013/0254264 A1
(43) Pub. Date: Sep. 26, 2013

(54) TETHERING METHOD, COMPUTING DEVICES, SYSTEM AND SOFTWARE

(71) Applicant: 26ONES INC., Halifax (CA)

(72) Inventors: Stephen James Frederic Hankinson, Hammonds Plains (CA); Patrick Ian Wayne Hankinson, Halifax (CA); Chad Douglas Murphy, Porters Lake (CA)

(21) Appl. No.: 13/789,207

(22) Filed: Mar. 7, 2013

Related U.S. Application Data
(60) Provisional application No. 61/607,730, filed on Mar. 7, 2012.

(51) Int. Cl. H04L 29/06

(52) U.S. Cl. CPC H04L 29/06047
USPC 709/203

(57) ABSTRACT

In one aspect, a mobile browser may be used to facilitate tethering of a client computing device to a mobile device. A first data connection may be opened between a client computing device seeking internet access and a browser application executing in the mobile browser. A second data connection may be opened between the browser application executing in the browser and an internet server. The browser application may automatically relay internet-destined data received from the client device to the internet server and may further automatically relay internet-originated data received from the internet server to the client device. In another aspect, a gateway identifier identifying a gateway for accessing the internet via a wireless LAN data connection may be modified or deleted to cause the mobile device to use a cellular data network data connection, rather than the wireless LAN data connection, for relaying internet-destined data from the client computing device.

### TECHNICAL FIELD

This disclosure pertains to the tethering of computing devices, or to the sharing of internet connectivity of internet-capable mobile devices with computing devices.

### BACKGROUND

A mobile device may share its internet connectivity with a proximate computing device. This may be referred to as the tethering of the computing device to the mobile device. The computing device may connect to the mobile device wirelessly, e.g. via wireless LAN (e.g. Wi-Fi) or Bluetooth, or via a physical cable (e.g. via USB connection) for example. Software executing on the mobile device may then relay internet-bound data from the computing device to the internet and, in return, data from the internet to the computing device. The software may for example be pre-installed by a mobile telephony service provider.

### BRIEF DESCRIPTION OF THE DRAWINGS

In the figures which illustrate at least one exemplary embodiment:

FIG. 1 is a schematic diagram illustrating an exemplary system in which tethering of a client computing device is performed using multiple mobile devices and an internet proxy server;

FIG. 2 is a schematic view of a client computing device of FIG. 1;

FIG. 3 is a schematic view of one of the mobile devices of FIG. 1;

FIGS. 4A-4C are flowcharts illustrating operation of the client computing device of FIG. 1 for facilitating tethering;

FIGS. 5A-5D are flowcharts illustrating operation of one of the mobile devices of FIG. 1 for facilitating tethering;

FIGS. 6A-6C are flowcharts illustrating operation of the internet proxy server of FIG. 1 for facilitating tethering;

FIG. 7 is a schematic diagram illustrating another exemplary system in which tethering of a client computing device is performed using a single mobile device and an internet proxy server;

FIG. 8 is a schematic diagram illustrating another exemplary system in which tethering of a client computing device is performed using multiple mobile devices without an internet proxy server;

FIGS. 9A and 9B are flowcharts illustrating operation of one of the mobile devices of FIG. 8 for facilitating tethering; and

FIG. 10 is a schematic diagram illustrating another exemplary system in which tethering is performed without an internet proxy server;

### DETAILED DESCRIPTION

The following clauses provide a description of various aspects of the present disclosure.

A. Certain aspects of the present disclosure pertain to operation of a mobile device in a proxied or proxyless embodiment.

In one aspect, there is provided a method of using a mobile browser on a mobile device to facilitate tethering of a client computing device to the mobile device, the method comprising: opening a first data connection between the browser application executing in the mobile browser on the mobile device and the client computing device, the first data connection being referred to as a client device data connection; opening a second data connection between the browser application executing in the mobile browser on the mobile device and an internet server, the second data connection being referred to as an internet server data connection; using the browser application executing in the mobile browser, automatically relaying internet-destined data received from the client device data connection to the internet server data connection and automatically relaying internet-originated data received from the internet server data connection to the client device data connection.

In some embodiments of the above method, the first data connection is a WebSockets data connection and wherein the second data connection is a WebSockets data connection.

In some embodiments of the above methods, the internet server is an internet proxy server.

In another aspect, there is provided a non-transitory machine-readable medium storing software that, when executed by a processor of a mobile device, effects any one of the above methods.

In another aspect, there is provided a mobile device comprising a processor and memory storing software that, when executed by the processor, causes the processor to effect any one of the above methods.

B. Other aspects of the present disclosure pertain to operation of an internet proxy server in data communication with multiple mobile devices.

In one aspect, there is provided a method of facilitating tethering of a client computing device to a plurality of mobile devices, the method comprising: at an internet proxy server having a data connection with each of a plurality of mobile devices, receiving internet-originated data destined for a client application executing either at the client computing device that is tethered to the plurality of mobile devices or at a separate computing device in data communication with the client computing device; at the internet proxy server, automatically apportioning the internet-originated data among the plurality of data connections for transmission to the plurality of browser applications for relaying to the client computing device.

In some embodiments of the above method, the automatic apportioning is performed among the data connections on a round-robin basis or based on determined signal quality of each of a plurality of cellular data connections over which the plurality of data connections are respectively carried.

In some embodiments of the above method, the automatic apportioning among the data connections comprises assessing, for each of the plurality of mobile devices with which the plurality of data connections have respectively been made, of an amount of unused data before an operative mobile data plan cap is reached.

In some embodiments of the above method, the automatic apportioning apportions more data to a data connection having a large amount of unused data than to a data connection having a small amount of unused data.

In another aspect, there is provided a non-transitory machine-readable medium storing software that, when executed by a processor of an internet proxy server, effects any one of the above methods.

In another aspect, there is provided an internet proxy server comprising a processor and memory storing software that, when executed by the processor, causes the processor to effect any one of the above methods.

C. Still other aspects of the present disclosure pertain to operation of a client-side tethering support application mechanism that a client computing device may use to communicate with single mobile device using a browser application.

In one aspect of the present disclosure, there is provided a method of facilitating tethering of a client computing device to a mobile device, the method comprising: at a client computing device having a data connection with a browser application executing in a mobile browser of a mobile device, the browser application having opened a data connection for internet connectivity through a cellular data network, transmitting internet-destined data from a client application, the client application executing either at the client computing device or at a separate computing device in data communication with the client computing device, to the browser application via the data connection; at the client computing device, receiving internet-originated data destined for the client application from the browser application executing in the mobile browser of the mobile device via the data connection.

In another aspect, there is provided a non-transitory machine-readable medium storing software that, when executed by a processor of a client computing device, effects any one of the above methods.

In another aspect, there is provided a client computing device comprising a processor and memory storing software that, when executed by the processor, effects any one of the above methods

D. Still other aspects of the present disclosure pertain to operation of a client-side tethering support application mechanism that a client computing device may use to communicate with multiple mobile devices not necessarily executing browser applications.

In one aspect, there is provided a method of facilitating tethering of a client computing device to a plurality of mobile devices, the method comprising: at a client computing device having a data connection with each of a plurality of mobile devices each having internet connectivity through a cellular data network, automatically apportioning internet-destined data from a client application, the client application executing either at the client computing device or at a separate computing device in data communication with the client computing device, among the plurality of data connections for transmission to the plurality of mobiles devices; at the client computing device, receiving internet-originated data destined for the client application from the plurality of data connections with the respective plurality of mobile devices.

In some embodiments of the above method, the client computing device is a mobile device having internet connectivity via a cellular data network data connection and wherein the automatically apportioning of the internet-destined data additionally apportions some of the internet-destined data from the client application to the cellular data network data connection of the client computing device.

Some embodiments of the above method further comprise receiving additional internet-originated data, destined for the same client application, from the cellular data network connection of the client computing device and delivering the additional internet-originated data to the client application along with the internet-originated data received from the plurality of data connections.

In some embodiments of the above method, the automatic apportioning is performed among the data connections on a round-robin basis or based on a determined quality of the internet connectivity of each of the respective mobile devices.

In some embodiments of the above method, the automatic apportioning among the data connections comprises assessing, for each of the plurality of mobile devices with which the plurality of data connections have respectively been made, of an amount of unused data before an operative mobile data plan cap is reached.

In some embodiments of the above method, the automatic apportioning apportions more data to a data connection having a large amount of unused data than to a data connection having a small amount of unused data.

In some embodiments of the above method, each of the data connections is with a browser application executing in a mobile browser of the respective mobile device, the browser application for relaying the internet-destined data out over the cellular data network and for relaying internet-originated from the cellular data network towards the client application.

In another aspect, there is provided a non-transitory machine-readable medium storing software that, when executed by a processor of a client computing device, effects any one of the above methods.

In another aspect, there is provided a client computing device comprising a processor and memory storing software that, when executed by the processor, effects any one of the above methods.

E. Still other aspects of the present disclosure pertain to operation of a mobile device for forcing internet-destined data over cellular data connection rather than a wireless LAN connection such as a Wi-Fi™ data connection.

In one aspect, there is provided a method of facilitating tethering of a client computing device to a mobile device over an IEEE 802.11 protocol compliant wireless local area network (WLAN), the method comprising: at a mobile device having a data connection with a client computing device over an IEEE 802.11 protocol compliant WLAN, the data connection being referred to as a Wi-Fi™ data connection, the Wi-Fi™ data connection having an associated gateway identifier identifying a gateway for accessing the internet via the Wi-Fi™ data connection, the mobile device further having a cellular data network data connection to the internet, modifying or deleting the gateway identifier identifying the gateway for accessing the internet via the Wi-Fi™ data connection so as to cause the mobile device to use the cellular data network data connection rather than the Wi-Fi™ data connection for relaying internet-destined data from the client computing device.

In some embodiment of the above method, the modifying or deleting results in a modified or deleted gateway identifier that indicates that the gateway is unavailable.

In another aspect, there is provided a method of facilitating tethering of a client computing device to a mobile device over an IEEE 802.11 protocol compliant wireless local area network (WLAN), the method comprising: at a mobile device having a data connection with a client computing device over an IEEE 802.11 protocol compliant WLAN, the data connection being referred to as a Wi-Fi™ data connection, the mobile device further having a cellular data network data connection to the internet; upon determining that a destination Internet Protocol (IP) address of an internet-destined IP packet received from the client computing device falls within range of IP destination addresses for which transmission to the internet over the Wi-Fi™ data connection is precluded, using the cellular data network data connection to transmit the internet-destined IP packet towards the internet.

In some embodiments of the above method, the range of IP destination addresses for which transmission to the internet over the Wi-Fi™ data connection is precluded is defined using at least one Link-Local Address.

In another aspect, there is provided a non-transitory machine-readable medium storing software that, when executed by a processor of a mobile device, effects any one of the above methods.

In another aspect, there is provided a mobile device comprising a processor and memory storing software that, when executed by the processor, causes the processor to effect any one of the above methods.

The term software as used herein encompasses processor-executable instructions in any form however stored or represented.

In this document, the term “exemplary” is understood to mean “an example of” and does not necessarily connote that the example is preferred or exceptional in any way.

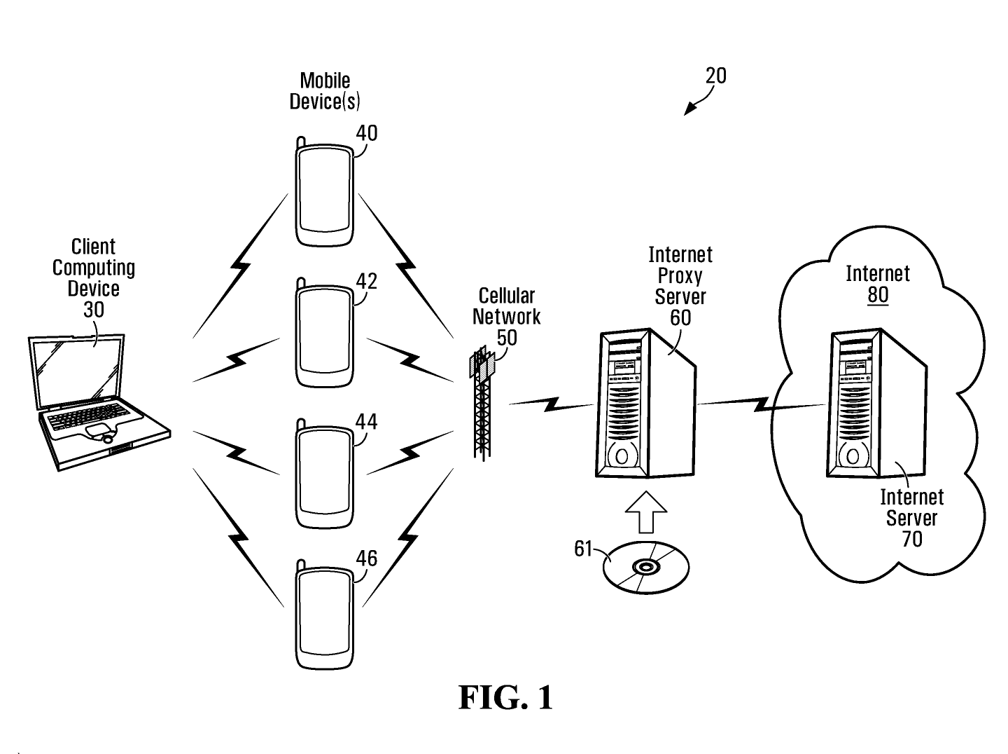

FIG. 1 illustrates an exemplary system 20 in which tethering of a client computing device is performed using multiple mobile devices and an internet proxy server. The system 20 includes a client computing device 30 (also referred to herein as a “target device”), a plurality of mobile devices 40, 42, 44 and 46, which may be of the same or different makes/models or types, a cellular network 50, and an internet proxy server 60 (or simply “proxy server”). Also illustrated is the internet 80, including an exemplary internet server 70.

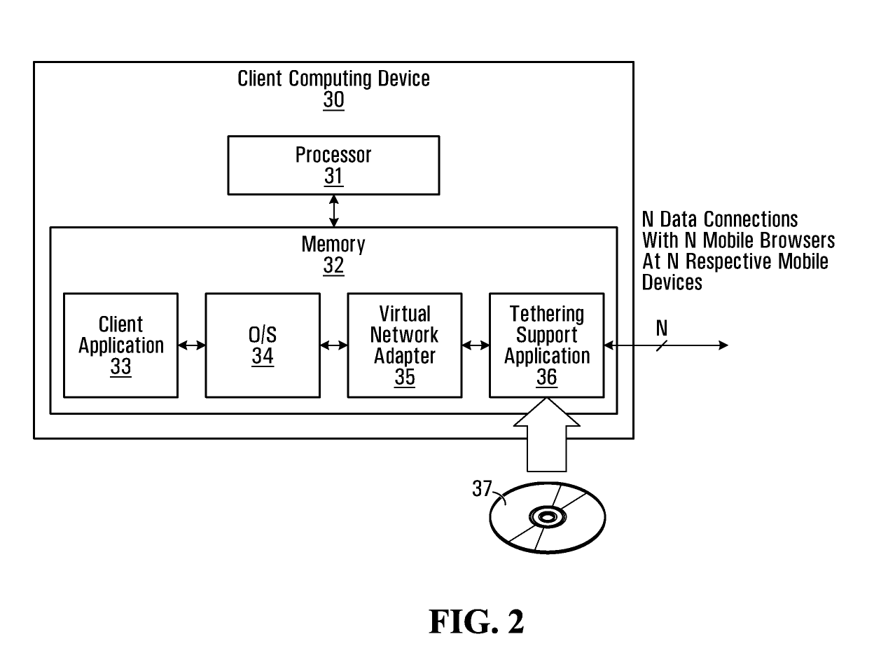

Client computing device 30 may be any computing device that executes a client application 33 requiring access to the internet 80 (e.g. to exemplary internet server 70) during its execution. The computing device 30 may be, for example, a laptop computer, tablet computer, router, or virtually any other type of computing device. The foregoing list is not intended to be exhaustive. The client computing device 30 is illustrated in greater detail in FIG. 2.

Referring to FIG. 2, it can be seen that the client computing device 30 comprises a processor 31 (or possibly more than one processor) in communication with memory 32. The memory 32 may be volatile or non-volatile memory, or a combination of the two.

Memory 32 stores a client application 33, an operating system (“O/S”) 34, a virtual network adapter 35, and a tethering support application 36 (also referred to herein as a “custom application”). The client computing device 30 may have other hardware, software and/or firmware components, in memory 32 or elsewhere, that are not illustrated for the sake of brevity.

Client application 33 may be a software application, program, utility or module that requires access to the internet 80. The client application 33 may be, for example, a web browser, a Telnet program or utility, a Skype™ voice and/or video over IP calling application, an File Transfer Protocol (FTP) client, or any of a wide range of other possibilities. The client application 33 may use any one or more of a wide variety of internet communications protocols, such as HyperText Transfer Protocol (HTTP) for accessing the world wide web, FTP for file transfer (RFC 959), Telnet for telnet sessions (RFC 854), Internet Relay Chat (RFC 1459), Transmission Control Protocol (TCP) (RFC 793), User Datagram Protocol (UDP) (RFC 768), Generic Routing Encapsulation (GRE) (RFC 2784), Internet Control Message Protocol (ICMP) (RFC 792), or other types of client applications. All of the RFCs in listed this document are accessible from www.ietf.org/rfc/rfc<RFC#>.txt, where <RFC#> is replaced with the RFC number (without any leading zeros), and are hereby incorporated by reference.

The O/S 34 is an operating system such as Microsoft™ Windows™, Unix™, Mac OS X, Linux, or other operating system, for example.

The virtual network adapter 35 is a software equivalent of a physical network adapter (sometimes referred to as a network interface card). The virtual network adapter 35 appears to the O/S 34 in the same way as a piece of hardware, despite being implemented in software. For example, responses to the O/S 34 that are normally generated by hardware in a physical network adapter are generated in a driver that forms part of the virtual network adapter 35. The virtual network adapter 35 essentially fools the O/S 34 into believing that the client computing device 30 is connected to a network, such as an Ethernet Local Area Network (LAN), that provides access to the internet. In reality, all data sent to, and received from, the virtual network adapter 35 by the O/S 34 is actually relayed by the tethering support application 36 to/from the mobile devices 40, 42, 44 and 46 to which the client computing device 30 is tethered, transparently from the perspective of the O/S 34 and client application 33.

The tethering support application 36 is a software application that helps to establish and maintain data connections between the client computing device 30 and each of mobile devices 40, 42, 44 and 46 in support of tethering. The data connections may be established and maintained over various types of media, notably including wired media (e.g. over a USB cable interconnected between the client computing device 30 and each of more mobile devices 40, 42, 44 and 46—this typically requires the client computing device 30 to have multiple USB ports) or a wireless medium (e.g. a wireless connection governed by, say, Bluetooth™, Wi-Fi™ (i.e. any one of the Institute of Electrical and Electronics Engineers (IEEE) 802.11 family of standards, including IEEE 802.11a, b, g or n, and future versions), ZigBee or any other mechanism). The data transport mechanism used over each data connection may vary, but might for example be a socket connection over Wi-Fi™, RFCOMM channel over Bluetooth™, or a proprietary format over USB, to name but a few examples.

The data connections are used to carry data in two directions. In the first direction, internet-destined data originating from the client application 33 is carried from the client computing device 30 to the mobile devices 40, 42, 44 and 46 over the multiple data connections. Such internet-destined data may be referred to as “outgoing” or “outbound” data. This label is from the perspective of the client computing device 30, which is the perspective that will be used throughout this description for data direction. In the opposite direction, internet-originated data is carried from the mobile devices 40, 42, 44 and 46 to the client computing device 30 over the multiple data connections. Such internet-originated data may be referred to as “incoming” or “inbound” data.

The tethering support application 36 is designed to accept and manage data connections from any number of mobile devices 40, 42, 44 and 46 concurrently. The number of data connections maintained by the tethering support application 36 may be referred to generally as N, where N is a positive integer representing the number of mobile devices being used to access the internet (four in the present example embodiment). The tethering support application 36 is responsible for apportioning outgoing data to the N data connections using one or more operative techniques (e.g. round-robin, proportionally based on signal strength or signal quality, based upon amount of data remaining, i.e. unused data, before a mobile data plan cap, i.e. bandwidth cap or bit cap, is reached, or others, as will be described). An objective may be to effectively utilize the bandwidth of each of the N data connections. When outgoing data is so apportioned, a faster apparent outgoing data speed may result than may otherwise be possible with only a single mobile device. A similar effect may be observed for incoming data.

The nature of the operations performed by the tethering support application 36 are such that, in some embodiments, it may lack a graphical user interface, and may “run in the background,” possibly with little user awareness of its operation.

One or more of the client application 33, virtual network adapter 35 and/or tethering support application 36 may be loaded from a machine-readable medium 37, such as an optical disk, magnetic storage medium or read-only memory for example.

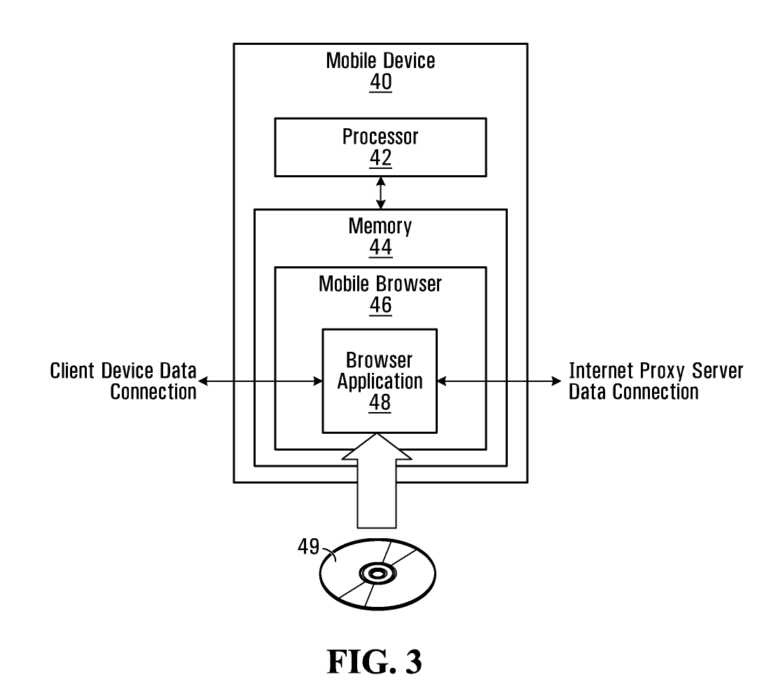

Referring to FIG. 1, mobile devices 40, 42, 44 and 46 are internet-capable mobile electronic computing devices such as smartphones (e.g. HTC™, Samsung™, Apple™ or RIM™ devices executing Android™, iOS™ or BlackBerry™ operating systems), cell phones, personal digital assistants (PDAs) or other types of devices. Being internet-capable means that the mobile devices are capable of accessing the internet over a cellular data connection (also referred herein to as a cellular data network data connection), e.g. via a 3G, 4G, EDGE or CDMA cellular network for example. An exemplary mobile device 40 is illustrated in greater detail in FIG. 3. The other mobile devices 42, 44 and 46 may have a similar structure, although they may vary if they are different types of mobile devices.

Referring to FIG. 3, a simplified schematic diagram of a mobile device 40 is shown. As illustrated, the mobile device 40 comprises a processor 42 (or possibly more than one processor) in communication with memory 44. The memory 44 may include volatile, non-volatile memory, or a combination of the two. Memory 44 stores a mobile browser application 46.

A mobile browser application is a web browser designed or optimized for use on a mobile device such as a smartphone, cell phone or PDA. Mobile browsers are typically optimized to display web content efficiently for small screens on portable devices. Beyond being able to render traditional HyperText Markup Language (HTML) pages, mobile browsers may be capable of executing one or more of the following technologies, which may be referred to as data streaming technologies: Websockets (as described in RFC 6455 (www.ietf.org/rfc/rfc791.txt), which is hereby incorporated by reference hereinto), AJAX, Java™ applets, JavaScript, Comet, Long polling, hidden iFrame, XmlHttpRequest, Flash script, Silverlight script, HTTP Server PUSH, Pushlet or Flash XML Socket Relays, for example. Exemplary mobile browsers may include, but are not limited to Firefox™ for mobile, Safari™ and Opera™ Mobile. As will be appreciated, the capability of using such a technology can be leveraged to make a browser application act as a bridge in support of a tethering capability.

In particular, the above data communication protocols may allow for two-way communication between browser application 48 and the remote internet proxy server 60 (or in some embodiments, an internet server 70 directly—see below) instead of the convention request/response mechanism for which HyperText Transfer Protocol (HTTP) is designed. This approach allows a server (e.g. the internet proxy server 60) to send data to the browser application without the browser application specifically requesting it, e.g. by way of threads as described herein.

At runtime, the mobile browser 46 will execute a browser application 48 for facilitating tethering using the mobile browser 46. The browser application 48 may be a web page that is downloaded from the web over the air or may be preloaded on the mobile device 40. The browser application 48 may originate from a machine-readable medium 49, such as an optical disk, magnetic storage medium or read-only memory for example. In one embodiment, the medium 49 may be in, or may be used by, a web server from which the browser application 48 is downloaded.

The mobile device 40 may have other hardware, software and/or firmware components, in memory 44 or elsewhere, that are not illustrated in FIG. 3 for the sake of brevity.

Cellular network 50 is a cellular network such as an Enhanced Data Rates for GSM Evolution (EDGE), 3G, 4G, Code Division Multiple Access (CDMA) or other cellular data network capable of carrying data over cellular network frequencies between mobile devices 40, 42, 44 and 46 and a network gateway (not expressly illustrated) through which the data is passed to/from the internet proxy server 60.

Internet proxy server 60 is a hardware or software component (or possibly a combination) that that acts as an intermediary for requests from the client computing device 30 seeking resources from internet 80, regardless of which mobile device 40, 42, 44 or 46 is used to relay the request. In the system 20, all internet-destined data originating from client application 33 passes through the internet proxy server 60, as does all internet-originated data destined for client application 33. Operation of internet proxy server 60 may be governed by software which may be loaded or read from a machine-readable medium 61, such as an optical disk, magnetic storage medium or read-only memory for example.

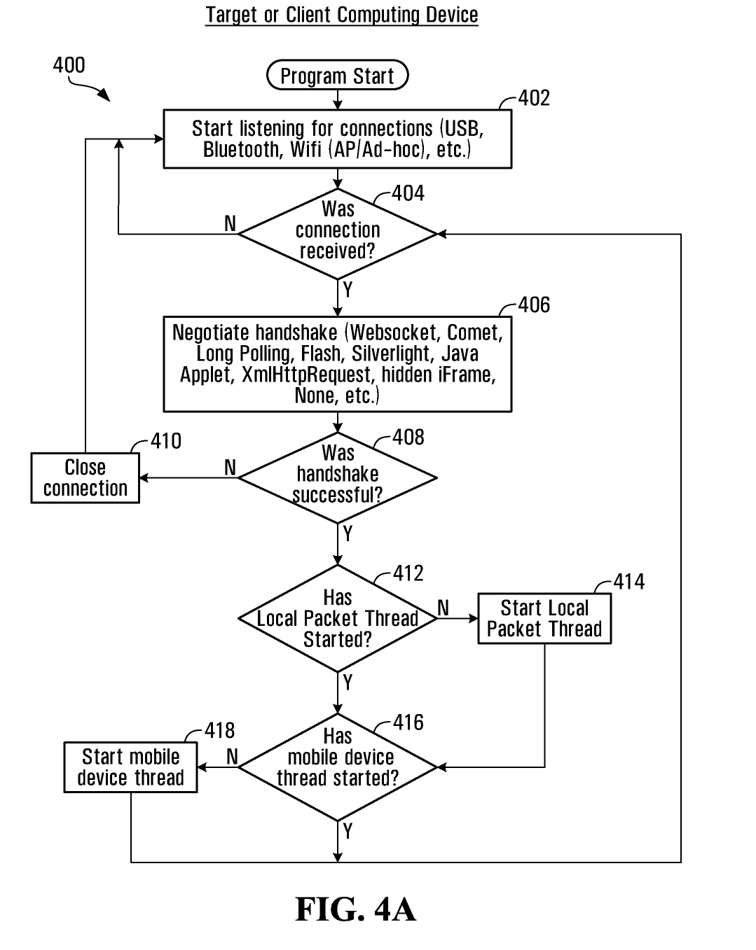

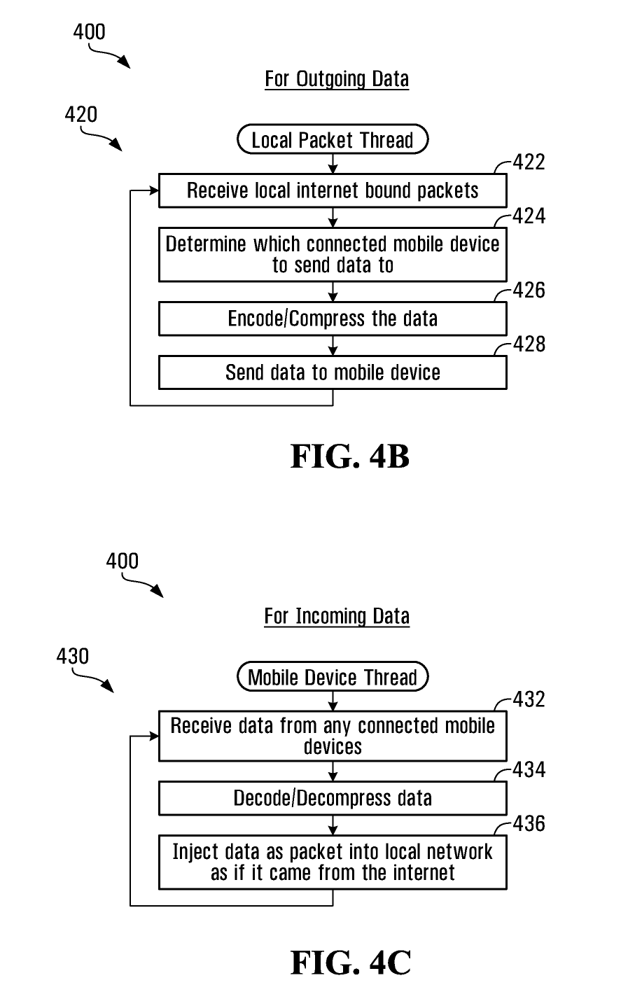

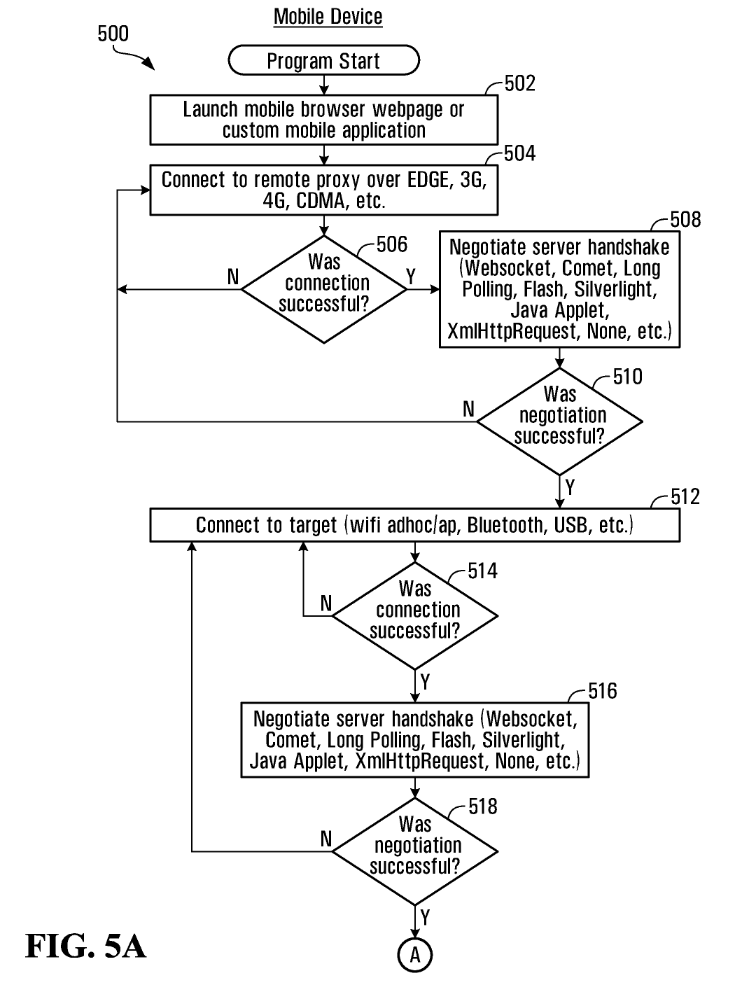

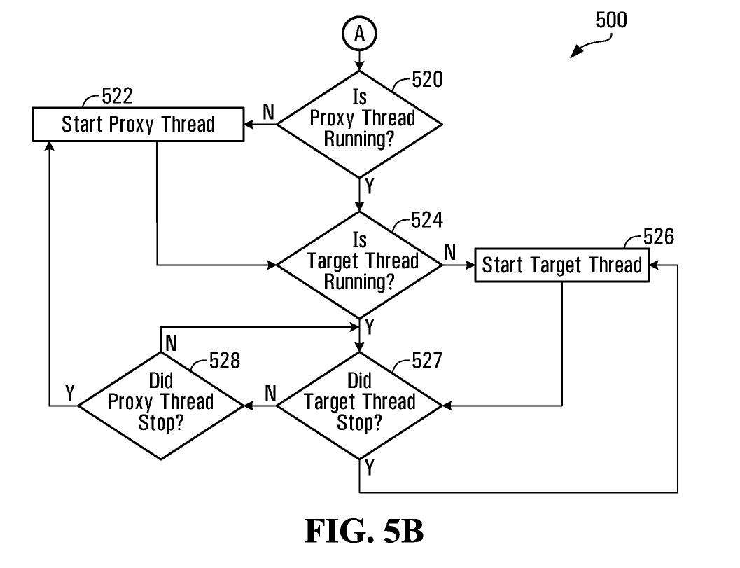

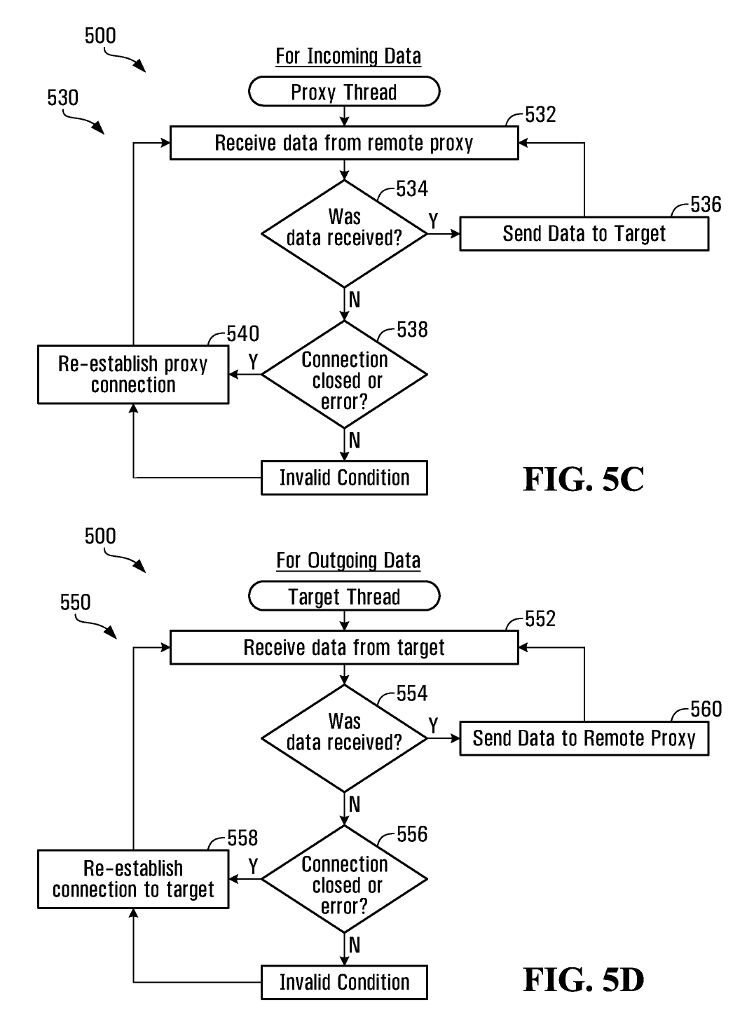

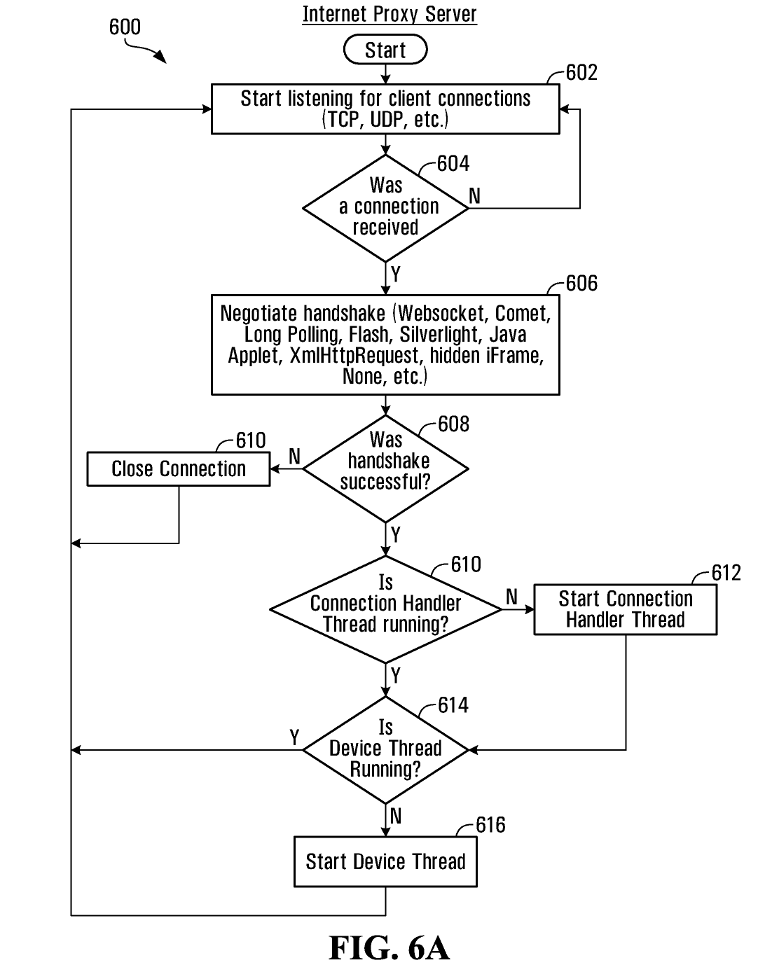

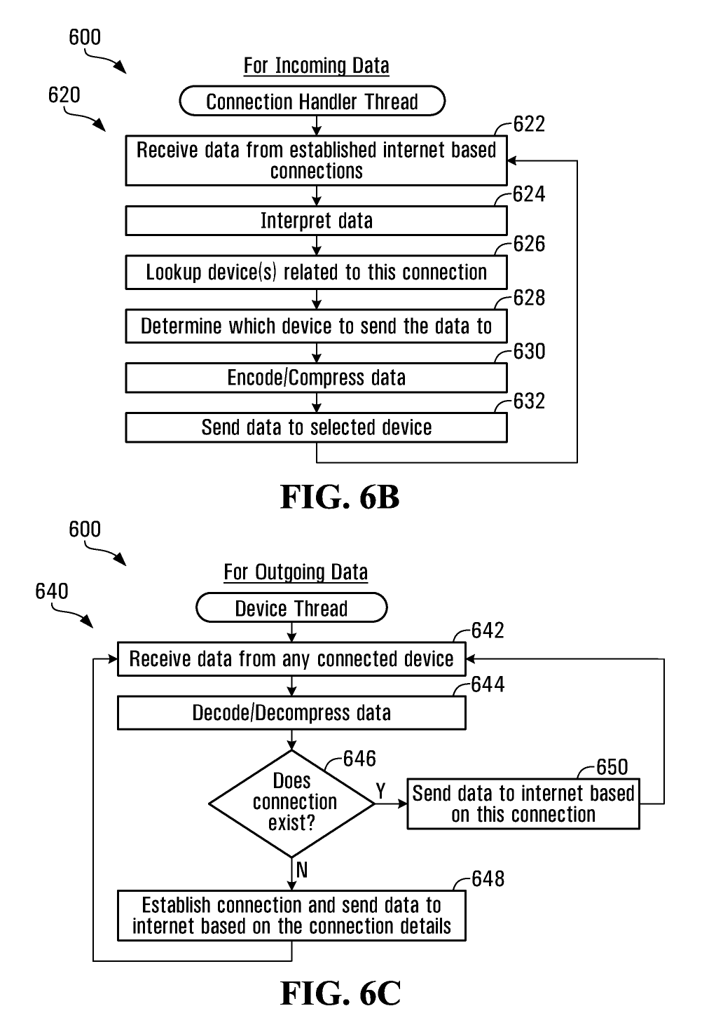

Operation of the system 20 for facilitating tethering of the client computing device 30 using mobile devices 40, 42, 44 and 46 is shown in FIGS. 4A-4C, 5A-5D and 6A-6C. FIGS. 4A-4C illustrates operation 400 of the client computing device 30. FIGS. 5A-5D illustrate operation 500 of an exemplary mobile device 40, with all other mobile devices 42, 44 and 46 operating in a similar manner. FIG. 6A-6C illustrate operation 600 of internet proxy server 60.

It is presumed that, initially, client application 33, is running on the client computing device 30 but has not yet made any request for internet resources.

Referring to FIG. 4A, the tethering support application 36 is invoked, e.g. by a user of the client computing device 30 or automatically (e.g. upon boot up). Upon invocation, the tethering support application 36 initially starts listening for data connection requests from any one of mobile devices 40, 42, 44 and 46 (operation 402). In the present embodiment, the tethering support application 36 responds to the opening of data connections, which initiated by mobile devices 40, 42, 44 and 46. This is not necessarily true of all embodiments. For example, if the data connections between the client computing device 30 and the mobile devices 40, 42, 44 and 46 are to be made via Bluetooth™, it may be desired for the tethering support application 36 to initiate data connections with nearby Bluetooth™ mobile devices upon discovering that they are nearby (i.e. upon scanning for them). In that case each mobile device 40, 42, 44 and 46 may wait for the client computing device 30 to initiate the data connection over Bluetooth™.

The tethering support application 36 may listen for data connection requests, e.g. over USB, Bluetooth™, Wi-Fi™, ZigBee or using another operative data connection mechanism, depending upon the embodiment. If no data connection is detected (404), listening continues.

Referring to FIG. 6A, internet proxy server 60 server also starts listening for data connections (e.g. via TCP, UDP, Datagram Congestion Control Protocol (DCCP), Stream Control Transmission Protocol (SCTP), HTTP, Transport Layer Security (TLS)/Secure Sockets Layer (SSL), Real-time Transport Protocol (RTP), SOCKet Secure (SOCKS), or another connection protocol, e.g. which runs on top of IPv4 (RFC 791) or IPv6 (RFC 2460)) from any of the mobile devices 40, 42, 44 or 46 (operation 602). If none are detected (604), listening continues.

At the mobile device 40, the mobile browser 46 is launched, e.g. by a user, and is instructed to load the browser application 48 (see FIG. 5A, 502). This may be achieved by causing the mobile browser 46 to go to a predetermined Uniform Resource Locator (URL) or web address where the browser application 48 (which may constitute a web page) is hosted, and downloading the browser application therefrom. This “pull” approach for obtaining the browser application 48 may facilitate the maintaining of a current version of browser application 48, in that each time the mobile device downloads the web page, it will be obtaining the latest version of the browser application 48. Other arrangements (e.g. push) could be used in alternative embodiments.

Upon interpreting the browser application 48, the mobile browser 46 opens two data connections. The first data connection is between the browser application 48 and the internet proxy server 60. The second data connection is between the browser application 48 and the client computing device 30 (and in particular, with the tethering support application 36 executing at the client computing device 30).

Regarding the first data connection, the browser application 48 opens a data connection to the internet proxy server 60 (FIG. 5A, operation 504). This data connection will be formed using the cellular network 50 and a gateway (not expressly illustrated). The browser application 48 may for example open a TCP or UDP connection over the cellular network 50 to the internet proxy server 60 via the gateway.

If the data connection was successfully opened (FIG. 5A, operation 506), then the browser application 48 engages in a handshaking procedure (operation 508 on the mobile device side, operation 606 of FIG. 6A on the internet proxy server side) with the internet proxy server 60 to agree upon the encoding/decoding and/or compression/decompression that will be employed over the data connection (e.g. WebSockets or TLS/SSL). The handshaking procedure is largely data communication technology specific and may differ for different technologies, such as Websockets, AJAX, Java™ applets, JavaScript, Comet, Long polling, hidden iFrame, XmlHttpRequest, Flash script, Silverlight script, HTTP Server PUSH, Pushlet or Flash XML Socket Relays, for example). In some embodiments, the internet proxy server 60 may initially advise the browser application 48, during handshaking, as to which data communication protocols the internet proxy server 60 supports, and possibly of an order of preference, to allow the browser application 48 to select a preferred data communication protocol that will be used between the browser application 48 and the internet proxy server 60.

In some embodiments, the data communication protocol may be predetermined, e.g. hard-coded into the tethering support application 36.

The choice of a particular data communications protocol to use may be based on desired parameters for an embodiment in question. For example, if it is desired to avoid frequent opening/closing of data connections and thus potentially avoid undesired battery consumption at the mobile device, Websockets might be chosen over certain other protocols. The reason is that, unlike Long Polling, Websockets does not require the opening/closing of connections for each datum that is sent. In another example, if it is desired to keep the headers of each transmission as compact as possible, it may be desired to use a communication protocol other than Long Polling, which requires sizable HTTP headers to be used that may not serve any substantive purpose. Various considerations such as these may lead to the use of different communication protocols for different embodiments, depending upon what parameters are important for the embodiment in question.

Another consideration may be a desire to avoid buffering by a wireless gateway, which may undesirably reduce data rates or throughput during tethering. When regular HTTP is used, many carrier's wireless gateways buffer HTTP requests/responses, possibly to examine or even modify the data This might be done, e.g., to cache web page data to provide a faster end user response in the case where another person on the wireless network has already loaded the page. The carrier may also insert ads or tracking cookies into the packets for their own purposes. These actions may lead to a reduction in the data rate or throughput as noted above. To address this potential problem, the data may be encrypted using, e.g., SSL. This may prevent the carrier from being able to see the contents of, or to modify/change, the data as it passes through the gateway. This may advantageously increase data rates/throughput in some embodiments.

A possible further consideration may be to choose a protocol that supports compression, to reduce the likelihood that mobile data plan subscribers will be required to pay high fees for excessive consumed bandwidth. For example, most SSL libraries allow for enabling compression of the data on the fly.

Upon successful handshaking, the internet proxy server 60 may add an entry to a table or other data structure that it uses to keep track of the various data connections between the internet proxy server 60 and mobile devices 40, 42, 44 and 46 (and possibly other mobile devices). The new entry may identify the data connection as well as the end user of the client computing device 30. End users may be identified, for example, based on a device ID or login credentials, possibly with a view to determining whether the user has a paid subscription to a tethering service provider, or whether the subscription has expired, or possibly whether the user is a trial user. A tethering service provider may be an entity responsible for providing the tethering support application 36, virtual network adapter 35 and browser application 48 for example. In some embodiments, device ID or login credentials may be checked in order to determine whether the end user is permitted to use the above-listed software, and possibly also identify mobile devices 40, 42, 44 and 46 as being related to a single client device (e.g. a user may register 4 phones with his/her account to be used with a single client device.). In this way, the internet proxy server 60 may keep track of which data connections can be used to access the end user.

If the handshaking is not successful (operation 510 of FIG. 5A, operation 608 of FIG. 6A), control of the mobile device 40 will return to operation 504 (FIG. 5A), and control of the internet proxy server 60 will return to operation 606 (FIG. 6A) after the data connection has been closed (operation 610, FIG. 6A). In this case, even though the mobile device 40 is the device that opened the data connection in the first place, the internet proxy server 60 may be the one to close it. The reason may be that the internet proxy server 60 is selective regarding what data connections it accepts, e.g. reduce the risk of inadvertently allowing a malicious data connection to be established which may cause the server 60 to be brought down.

If the handshaking was successful, then the mobile browser 46 initiates the opening of the second data connection, between the browser application 48 and the client computing device 30 (operation 512, FIG. 5A). The manner in which this is done may depend upon the data transport mechanism that is being used (e.g. a socket connection over Wi-Fi™, RFCOMM channel over Bluetooth™, proprietary format over USB, etc.). A check is performed as to whether the connection has been successfully received by the client computing device 30 (operation 404 of FIG. 4A, operation 514 of FIG. 5A). This may occur, for example, when the connection reaches a stage in which the browser application 48 and the client computing device 30 are each able to send each other data back and forth. For example, on a Wi-Fi™ connection using a socket, a successful receipt of a data connection may mean the mobile device 40 sent a SYN command, the client computing device 30 responded with a SYN/ACK, and then the mobile device 40 sent an ACK to cause the connection to move into an ESTABLISHED state. Regardless of the protocol/call that may be used, the connection will typically move from a CLOSED state to an ESTABLISHED state so that data transfer may occur between the two devices.

If the connection has been received, then the browser application 48 engages in a handshaking procedure (operation 406 of FIG. 4A on the client computing device side, operation 516 of FIG. 5A on the mobile device side) with the internet proxy server 60. The handshaking procedure is, again, largely data communication technology specific and may differ for different technologies, such as Websocket, Comet, Long Polling, Flash, Silverlight, Java™ Applet, XmlHttpRequest, or None, for example).

If the handshaking is not successful (operation 408 of FIG. 4A, operation 518 of FIG. 5), control of the client computing device 30 will return to operation 402 of FIG. 4A after the data connection has been closed (operation 410, FIG. 4A), and control of the mobile device 40 will return to operation 512 of FIG. 5A.

Referring to FIG. 5B, once the two data connections (i.e. the data connection from the mobile device 40 to the internet proxy server 60 and the data connection from the mobile device 40 to the client computing device 30) are open, the browser application 48 spawns two threads. The first thread 530, which may be referred to as the “proxy thread,” is for handling incoming (again, from the perspective of the client application 33 on the client computing device 30), internet-originated data from internet proxy server 60. This thread 530 is spawned in operation 522 and is shown in FIG. 5C. The second thread 550, which may be referred to as the “target thread,” is for handling outgoing, internet-destined data from client computing device 30. This thread 550 is spawned in operation 526 and is shown in FIG. 5D. By operation of these two threads, the browser application 48 will be able to receive data from the internet proxy server 60 and relay it to the client computing device 30 and receive data from the client computing device 30 and relay it to the internet proxy server 60, respectively. Essentially this allows the mobile browser 46 and browser application 48 to serve as a bridge in the overall data communications pathway between the client computing device 30 and the internet proxy server 60 and onto the internet 80. In steady state operation, data is passed back and forth across the bridge, between the established (i.e. already opened) data connections, to facilitate tethering of the client computing device 33 with the mobile device 40, with minimal overhead.

Notably, thread 530 is only spawned if a check, performed in operation 520 (FIG. 5B), reveals that no such thread is already running. Similarly, thread 550 is only spawned if a check, performed in operation 524 (FIG. 5B), reveals that no such thread is already running. These checks are performed in order to be able to restart the threads per operation 527 and/or 528 (FIG. 5B) if they either or both of the threads failed for any reason.

Referring to FIG. 4A, at the completion of handshaking with the browser application 48 at the mobile device 40, the tethering support application 36 at client computing device 30 similarly spawns two threads.

The first thread 420, which may be referred to as the “local packet thread,” is for handling outgoing, internet-destined data originating from client application 33. This thread 420 is spawned in operation 414 and is illustrated in FIG. 4B. The second thread 430, which may be referred to as the “mobile device thread,” is for handling incoming, internet-originated data from mobile device 40. This thread 430 is spawned in operation 418 and is illustrated in FIG. 4C. By operation of these two threads 420 and 430, the tethering support application 36 will be able to receive data from the virtual network adapter 35 and relay it to the mobile device 40 (or any other mobile device 42, 44 or 46), as well as receive data from the mobile device 40 (or any other mobile device 42, 44 or 46) and relay it to the virtual network adapter 35 for ultimate use by the client application 33, respectively.

Notably, thread 420 is only spawned if a check, performed in operation 412, reveals that no such thread is already in existence. Similarly, thread 430 is only spawned if a check, performed in operation 416, reveals that no such thread is already in existence. The reason these checks are performed is that the same threads 420, 430 are used to support data connections not only with the mobile device 40, but also with any other one(s) of the other mobile devices 42, 44 and 46, or others. If one of those other mobile devices 42, 44 or 46 had already formed a data connection with the tethering support application 36, then operations 414 and 418 would be skipped because the threads 420, 430 would already be in existence. It may be preferable to use only a single thread in each direction, e.g. instead of many threads, particularly on client computing devices with only one processor, to avoid unnecessary context switching between threads.

The tethering support application 36 may maintain a lookup table or similar data structure of all of the N data connections that are currently open with mobile devices 40, 42, 44 and 46.

Turning to FIG. 6A, at the completion of handshaking with the browser application 48 at the mobile device 40, the internet proxy server 60 spawns two threads.

The first thread 620, which may be referred to as the “connection handler thread,” is for handling incoming, internet-originated data from the internet 80. This thread 620 is spawned in operation 612 and is illustrated in FIG. 6B. The second thread 640, which may be referred to as the “mobile device thread,” is for handling outgoing, internet-destined data from the browser application 48 at mobile device 40. This thread 640 is spawned in operation 616 and is illustrated in FIG. 6C. By operation of these two threads 620 and 640, the internet proxy server 60 will be able to receive internet-originated data from the internet 80 and relay it to the mobile device 40 (or any other mobile device 42, 44 or 46), as well as to receive internet-destined data from the mobile device 40 (or any other mobile device 42, 44 or 46) and relay it to the internet 80, respectively.

Notably, thread 620 is only spawned if a check, performed in operation 610, reveals that no such thread is already in existence. Similarly, thread 640 is only spawned if a check, performed in operation 614, reveals that no such thread is already in existence. The reason these checks are performed is that the same threads 620, 640 are used to support data connections not only with the mobile device 40, but also with any other one(s) of the other mobile devices 42, 44 and 46. If one of those other mobile devices 42, 44 or 46 had already formed a data connection with the internet proxy server 60, then operations 612 and 616 would be skipped because the threads 620, 640 would already be in existence.

To illustrate how the above-described tethering architecture is used to provide internet access to the client application 33, an end-to-end transaction, from the client application 33 to the internet 80 and back, will now be described.

Consider an example in which the client application 33 is a web browser, such as Internet Explorer™ for example. A user of the client computing device 30 desirous of browsing the google.com website may type the URL “google.com” into an address window of the client application 33 and press the ENTER button. This instructs the client application 33 to request the home page of the google.com website from the internet 80.

The O/S 34 detects the presence of what appears to be a network adapter that is connected to the internet. For example, the virtual network adapter 35 settings may be configured with gateway IP and Domain Name System (DNS) addresses. The O/S 34 may have sent out DNS requests to resolve google.com into an IP address. The O/S 34, which may consider the virtual network adapter 35 as a physical adapter, may note that the adapter has a gateway. As such, the O/S 34 may accordingly consider it open to route IP packets to the internet via the virtual network adapter 35. When a DNS response identifies the IP address representing google.com, the O/S 34 may consider the virtual network adapter 35 to be physically connected to the internet 80 through the gateway specified in the virtual network adapter 35 settings.

Based on the foregoing, the O/S 34 (e.g. the network layer of the O/S 34) sends an IP packet, comprising an HTTP Get and the desired URL “google.com,” to the ostensible Ethernet adapter, which is actually the virtual network adapter 35. The packet may be an IPv4 (as defined in RFC 791, which is described in www.ietf.org/rfc/rfc791.txt) or IPv6 packet, as may conventionally be sent to a gateway in the case of a conventional internet-connected computing device. In the packet, the IP address of the client computing device 30 (CLIENTIP) may be identified as the source address, along with the relevant port (CLIENTPORT, i.e. whichever port number was chosen by the O/S 34, which may be port 80 but is not necessarily so) of the requested internet service.

Once the packet arrives at the virtual network adapter 35, the adapter 35 provides the packet to the tethering support application 36, whose thread 420 (FIG. 4B) is waiting for packets from the virtual network adapter 35. Upon receipt of a IP packet (operation 422, FIG. 4B), the tethering support application 36 selects one of the mobile devices 40, 42, 44 and 46 to use to relay the packet along towards its internet destination (operation 424, FIG. 4B), and then sends the packet to the selected mobile device based on that decision (operations 426, 428).

The logic used by the tethering support application 36 for determining which of the N mobile devices 40, 42, 44 and 46 to use to relay the IP packet towards its internet destination (or more generally, the logic used by the tethering support application 36 for determining how to apportion internet-destined data among the N data connections) may vary between embodiments. In some embodiments, a round-robin approach may be used to progressively apportion packets to the N data connections in a cyclical manner. This approach may employ a circular counter to identify the next data connection to use, where each data connection is associated with a particular number within the range of the circular counter. This may be done with a view to spreading outgoing data substantially evenly across the mobile devices 40, 42, 44 and 46, with a view to maximizing utilization of each of the data connections and/or balance the data load substantially evenly across the data connections.

In some embodiments, each browser application 48 executing at one of the mobile devices 40, 42, 44 and 46 may report back a signal quality/strength and/or connection type (e.g. EDGE, 3G, 4G, CDMA) of its data connection with the internet proxy server 60. Based on this information, the tethering support application 36 may estimate the bandwidth available on each of its N data connections and, based on the rate of outgoing packets, apportion or spread the packets between the mobile devices 40, 42, 44 and 46, e.g. so that each device is using its available bandwidth effectively. For example, the tethering support application 36 may apportion more outgoing data to a mobile device having a high quality connection to the internet proxy server 60 than to a mobile device having low quality connection to the internet proxy server 60.

In some embodiments, each browser application 48 executing at one of the mobile devices 40, 42, 44 and 46 may report back an amount of data remaining before a mobile data plan cap is reached and additional mobile data plan charges begin to accrue. This information may be obtained by the mobile device from the cellular data network 50 or may be maintained locally at the mobile device. Based on this information, the tethering support application 36 may apportion data among the N data connections proportionally to the amount of data remaining for the relevant mobile device used for that data connection. For example, the tethering support application 36 may apportion more outgoing data to a mobile device having a large amount of remaining data before a mobile data plan cap is reached than to a mobile device having small amount of remaining data before a cap is reached.

Various other approaches are possible.

Upon selecting a data connection (operation 424, FIG. 4B), the tethering support application 36 encodes and/or compresses the IP packet in accordance with the operative communication protocol being used over the selected data connection (operation 426, FIG. 4B). The encoding and/or compression to be used will be known from the handshaking that occurred between the tethering support application 36 and the browser application 48 of mobile device 40 when the data connection was created. The entirety of the IP packet may be encoded. This may allow the tethering architecture described herein to support various protocols without being required to know the details of their implementations. The TCP/IP stacks at the client computing device 30 and internet proxy server 60 should be able to understand the protocols encoded in the IP packet and handle them appropriately.

The encoded and/or compressed packet is then transmitted over the data connection to the browser application 48 at the mobile device 40.

Referring to FIG. 5D, thread 550 of browser application 48 receives the packet over the data connection with the tethering support application 36 (operations 552, 554). To the extent that any closure of the data connection or error had been detected (operation 556), the data connection with the tethering support application 36 would have been re-established (operation 558). In the present example, this is presumed not to have occurred. Ultimately, the packet is relayed to the internet proxy server 60 via the data connection between the browser application 48 and the internet proxy server 60 (operation 560). In some embodiments, this may essentially be a straight handoff, without any processing of the packet. In some embodiments, the send call on the WebSocket API may perform some encoding, but that may not be governed by code in browser application 48. Rather, such encoding may be built into the mobile browser 46. In such embodiments, the tethering support application 36 should be designed to decode whatever the mobile browser 46 encoded.

Referring to FIG. 6C, thread 640 of internet proxy server 60 receives the encoded and/or compressed packet over its data connection with the browser application 48 (operation 642) and applies appropriate decoding and/or decompression to obtain the original IP packet (operation 644). The decoding/decompression to be applied may be known based on handshake performed in operation 606 or may be hardcoded for example.

In the event that the client application 33 had sent many outgoing IP packets using all of the N data connections, the internet proxy server 60 may be able to reassemble the packets and transmit them over a single outgoing internet connection. In this regard, the TCP/IP stack in the internet proxy server 60 may perform any reassembly that is required. This may be by operation of standard rules of the protocol in question, e.g. sequence numbers and acknowledgment numbers in TCP may be used by the TCP/IP stack to properly order and confirm receipt of data.

Next, the internet proxy server 60 checks whether a connection to the internet 80 exists (operation 646, FIG. 6C). This may entail looking up Source/Destination IP/Port in a standard network address translation (NAT) table to see whether it has already been added to the table, e.g. checking the NAT table for a TCP:google.com:80:CLIENTIP:CLIENTPORT mapping. If no connection exists, one is established. This may entail opening a connection to the desired destination (google.com) on port 80 of the internet proxy server 60. In the NAT table, a mapping TCP:google.com:80:CLIENTIP:CLIENTPORT:SERVERIP:SERVERPORT may be created (where SERVERIP represents the IP address of the internet proxy server 60, and SERVERPORT represents port being used, which will match the CLIENTPORT), and the internet proxy server 60 connects to google.com on port 80 from SERVERIP SERVERPORT. If this connection were already known, i.e. if the lookup found an established connection in the NAT table, the internet proxy server 60 would know to route the packet to google.com:80 from SERVERIP:SERVERPORT and would do so. In either case, the packet is sent to the appropriate URL and port based on the connection details (operation 648 or 650).

By conventional operation, the IP packet is relayed through the internet 80 to port 80 of the internet server 70 with which the URL “google.com” is associated.

The internet server 70 replies by sending a response to the internet proxy server 60. The response may comprise multiple (e.g. hundreds or thousands) of IP packets. Each of those packets will identify its destination as the IP address and port of the internet proxy server 60 from which the request packet was sent.

Referring to thread 620 of FIG. 6B, upon receiving one of those packets from the internet server 70 (operation 622), the internet proxy server 60 interprets the data (operation 624) and uses the information gleaned from the interpretation to identify the mobile devices 40, 42, 44 and 46 that can be used to access the identified destination. This may entail a reverse lookup in the NAT translation table, described earlier, with a view to matching the protocol, SERVERIP, SERVERPORT, destination IP, and destination port to find the CLIENTIP and CLIENTPORT. Based on the CLIENTIP and CLIENTPORT, a lookup can be performed to determine which mobile devices 40, 42, 44 and 46 the client application 33 is currently using and to send the response packet to one of those mobile devices 40, 42, 44 and 46.

In the present example, operations 624 and 626 reveal the existence of a total of four data connections to the destination, via mobile devices 40, 42, 44 and 46. One of those data connections is selected for the purpose of sending the data comprising the packet towards its destination (operation 628). The selection may be made according to an operative apportionment technique (e.g. round robin, proportionally based on signal strength, or others) that may be similar to the logic used by the tethering support application 36 for determining which of the N mobile devices 40, 42, 44 and 46 to use to relay the data in the outgoing direction. In some embodiments, the same approach that is used at the tethering support application 36 may be used here. Alternatively, it may be desired to optimize the internet proxy server 60 for speed, regardless of the approach taken in the opposite direction at the tethering support application 36, since it is desired for the internet proxy server 60 to handle as many simultaneous client applications 33 as possible, with a view to reducing server operating costs. In some embodiments, the apportionment logic may seek to maximize utilization of each of the data connections or to balance the data load substantially evenly across the data connections. Regardless of the approach used, it is presumed that the data connection with mobile device 40 is selected in this example.

The internet proxy server 60 then encodes and/or compresses the packet in accordance with the operative communication protocol being used over the selected data connection (operation 630). In the present embodiment, the entire packet is sent. A substitution of CLIENTIP CLIENTPORT for the internet proxy server's SERVERIP SERVERPORT may be made before the packet is sent. This may be handled by the NAT translation logic of the O/S at the internet proxy server 60 for example. The encoding and/or compression to be used will be known from the handshaking that occurred between the internet proxy server 60 and the browser application 48 of mobile device 40 when the data connection was created.

The encoded and/or compressed data is then transmitted (operation 632) over the data connection to the browser application 48 at the mobile device 40.

Referring to FIG. 5C, thread 530 of browser application 48 receives the data over the data connection with the tethering support application 36 (operations 532, 534). To the extent that any closure of the data connection or error had been detected (operation 538), the data connection with the tethering support application 36 would have been re-established (operation 540). Ultimately, the packet is relayed to the tethering support application 36 at the client computing device 30 via the data connection between the browser application 48 and the client computing device 30 (operation 536). The nature of the handoff may be as described above in the opposite direction.

Referring to FIG. 4C, thread 430 of the tethering support application 36 receives the packet over the data connection with the browser application 48 (operation 432). Decoding/decompression is performed upon the data (operation 434). This decoding/decompression will generally be complementary to the encoding/compression that was performed in operation 426.

Thereafter, the data is “injected” into the O/S 34 as if it had originated from the internet (operation 436). In particular, the virtual network adapter 35 provides the resultant packet to the O/S 34 using a similar mechanism to that employed with convention hardware network adapters. For example, an IPv4 or IPv6 packet (depending upon the embodiment) may be created in which the Destination Address is set to the CLIENTIP address, the Destination Port is set the port CLIENTPORT, and the Source IP Address and Source Port are set to the internet service that ostensibly provided the packet (google.com) according to an operative NAT protocol. The IP address of google.com may be know from an earlier performed DNS lookup, which may have occurred after the client application user pressed ENTER in the address bar of the web browser (client application 33).

The O/S 34 determines that the packet is destined for the client application 33. To the extent that any other ones of the hundreds or thousands of response packets from google.com are also received, the O/S 34 is able to reassemble these in the IP stack that forms part of the O/S 34, so that the client application 33 will be able to understand the response.

Ultimately, when all the packets have been received, the client application 33 renders the resultant “google.com” web page.

As will be appreciated, because the tethering support application 36 apportions outgoing data from the client application 33 among N data connections with the mobile devices 40, 42, 44 and 46 that are operating in parallel, the upper limit of upload speed experienced by the client application overall may effectively be the sum of the transmission speeds of all of the mobile devices 40, 42, 44 and 46 (i.e. of all of the data connections established between those mobile devices and the internet proxy server 60). A similar effect may result for download speeds in the opposite direction. The more mobile devices that are used, the faster the effective upload and download speeds may become, and the larger overall bandwidth (throughput) that will be provided. When the cumulative speed and bandwidth provided by the set of mobile devices 40, 42, 44 and 46 exceeds the connection speed and bandwidth of internet proxy server 60 with the internet 80, the latter may become the effective upper limit on speed and bandwidth of the overall internet connection experienced by the end user.

In some embodiments, the data connections between the client computing device 30 and the browser application 48 may be carried over Wi-Fi™. In such embodiments, a problem may arise at the mobile devices 40, 42, 44 and 46. In particular, upon connection to the Wi-Fi™ network, each mobile device may be pre-programmed to use the Wi-Fi™ connection, in favor of the cellular data network to which the mobile device also has access, whenever any data is to be sent. The reason that mobile device platforms may be pre-programmed to favor Wi-Fi™ for all data communications may be that the Wi-Fi™ connection usually provides the necessary internet access and is typically cheaper than accessing data over a cellular data network. This potential problem may be circumvented using one of two approaches.

In one approach, the mobile device may be configured so it can “see” the Wi-Fi™ connection but does not consider the internet to be accessible through that connection, due to the apparent absence of a gateway. As is known in the art, a gateway is device is conventionally used in many types of internet access, including cellular data internet access. Gateways are described in RFC 823, which is hereby incorporated by reference hereinto (www.ietf.org/rfc/rfc823.txt). The gateway in this example acts as a translator between a cellular protocols such as EDGE, 3G, 4G, or CDMA and an internet protocols such as TCP/IP. When such a gateway is not believed to be available, the mobile device may refrain from sending the request over the cellular data network. The mobile device may believe the gateway to be unavailable if the gateway identifier (IP address) in the IP settings of the Wi-Fi™ connection at the mobile device 40 is blanked out or overwritten with a dummy or null value.

In another approach, a Link-Local Address may be used. A Link-Local Address is an Internet Protocol address that is intended only for communications within a segment of a local network or a point-to-point connection to which a host is connected. This may be used to define a range of IP addresses that are not to be sent out to the internet. Link-Local Addresses are described in RFC 3927, which is known in the art and is hereby incorporated hereinto (www.ietf.org/rfc/rfc3927.txt). Link-Local Addresses may achieve the desired result essentially because a router will not forward packets with Link-Local Addresses to a gateway. That is, by using a Link-Local Address (within the range) as the IP address of the WLAN hardware at the mobile device 40, and by using a non-Link Local Address (outside the range) as the IP address for the cellular data connection, the desired effect will be achieved. At the client computing device 30, the WLAN card may similarly have been assigned a link-local address (within the range), and the virtual network adapter 35 may be assigned a non-Link Local Address (outside of the range), to cause the O/S 34 to send outgoing data destined for the internet via the virtual network adapter 35 (and, in turn, by the tethering support application 36) rather than directly to the WLAN card.

The above tethering architecture is adaptive to the addition or removal of one or more mobile devices from the N mobile devices 40, 42, 44 and 46 that are being used to facilitate tethering of the client computing device 30.

If a new mobile device is added to the system 20, operation 400, 500 and 600 for creating the requisite data connections with between the browser application 48 and the client computing device 30, and between the browser application 48 and the internet proxy server 60, will be performed as described above in conjunction with FIGS. 4A-C, 5A-5D and 6A-6C respectively. An exception is that the threads of tethering support application 36 and internet proxy server 60 would not need to be spawned, since they will have already been created when tethering with mobile device 40 was initiated.

If any of the mobile devices 40, 42, 44 and 46 are removed from the system 20, e.g. by being deactivated or moving out of the proximity of the client computing device 30, the data connections between that mobile device and the client computing device 30 and internet proxy server 60 will be closed. The remaining devices will assume carriage of the data traffic that had previously been carried by the departing device. This may be result naturally by operation of the apportionment techniques described above among the remaining data connections.

As will be appreciated, a potential advantage of using a browser application 48 for facilitating tethering as described above is that any mobile device having a suitable mobile browser 46 may be conveniently equipped to facilitate tethering merely by downloading the appropriate browser application 48 (e.g. by downloading a web page). This may be more straightforward than obtaining and installing a standalone application for this purpose. For example, no permission or certification need be obtained, e.g. from a centralized, online “app store,” for making the standalone application available for download onto certain platforms of mobile devices 40, 42, 44 or 46. Moreover, use of a browser application may obviate the need for building/maintaining different versions of standalone applications for compatibility with different mobile platforms. The reason is that the various mobile browsers that are already available for each platform may all be equally well-suited for executing the universal browser application 48. In effect, by placing the mobile device tethering logic in a browser application 48, the logic becomes universally compatible with all mobile devices having a mobile browser capable of executing the browser application and effecting one of the above data connection technologies.

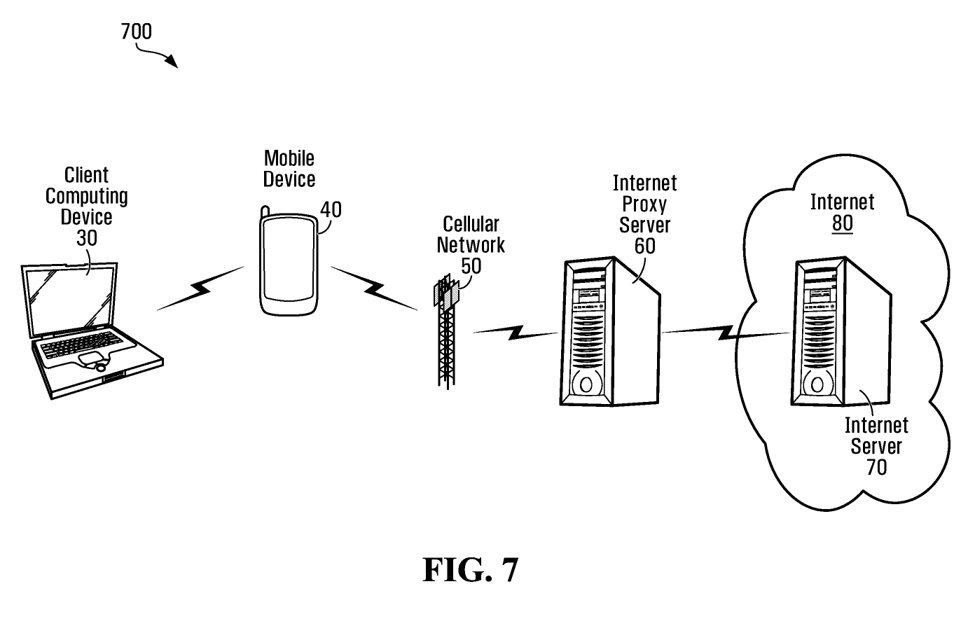

It is also possible to use the above-described system to provide internet access to the client application 33 even when only a single mobile device 40 is available, such as in system 700 of FIG. 7. In that case, operation 400, 500 and 600 for sending outgoing data from the client computing device 30 to the internet proxy server 60 and for receiving incoming data from the internet proxy server 60 to the client computing device 30 may differ primarily only in that no apportionment of the data (e.g. as in operations 424 of FIG. 4B and 628 of FIG. 6B) would effectively be performed in either direction, because no parallel data connections would exist. The upper limit of upload/download speed and bandwidth of the mobile device 40 may effectively become the upper limit for speed and bandwidth of the internet connection overall.

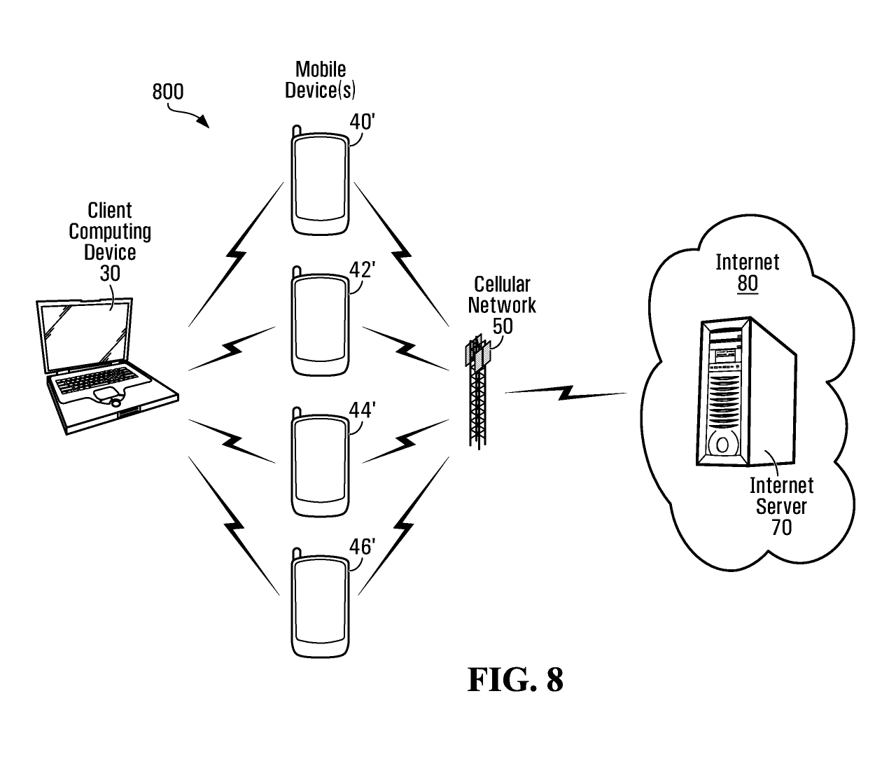

FIG. 8 illustrates an alternative embodiment in which tethering of the client computing device 30 is performed using multiple mobile devices without an internet proxy server. The mobile devices 40′, 42′, 44′ and 46′ are the same as described above, with the exception that the logic applied by the browser application 48 is different. For this reason, the reference numerals used to identify those devices have a trailing prime symbol (′). The reference numeral of the browser application similarly has a trailing prime symbol (′), i.e. reference numeral 48′, to distinguish it from the browser application 48 described above.

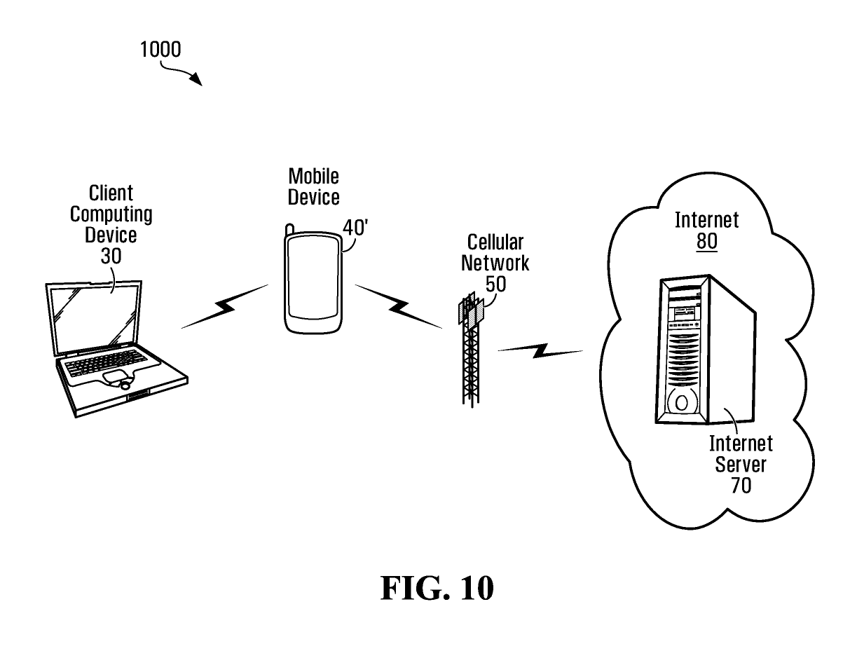

The tethering support application executing at the client computing device 30 (not expressly illustrated) will differ somewhat from the tethering support application 36 of FIG. 2. In particular, the tethering support application in this embodiment will maintain a list of connected mobile devices 40′, 42′, 44′ and 46′ and will keep track of which mobile device is being used to handle which client application internet protocol connection (e.g. HTTP, FTP, TCP, UDP, GRE, ICMP and/or IRC connection). The reason is that all outgoing packets for a specific internet protocol connection will be sent to the same mobile device, since that mobile device will handle all traffic back and forth for that specific internet protocol connection. When a new internet protocol connection is to be established (e.g. when a new client application requiring internet access is invoked), round robin or signal quality/type selection can be used to choose which connected mobile device will handle this new connection. As such, the apparent speed and bandwidth (throughput) for any single internet protocol connection (e.g. for a web download) may not differ from a single mobile device tethering embodiment (e.g. as in FIG. 10). However, if multiple internet-accessing client applications are executed at the client computing device 30, the speed and throughput of that set of multiple applications may be improved over other single mobile device tethering systems, since the internet traffic for each client application in the present system can be apportioned to a different mobile device (presuming enough such mobile devices are available).

The difference between system 20 and system 800 may alternatively characterized as follows. In system 20, when an outgoing packet associated with a particular client application 33 at client computing device 30 is sent towards the internet by a particular one of mobile devices 40, 42, 44 and 46, the response packet(s) may be returned by a different one of the mobile devices 40, 42, 44 and 46. In system 800, when an outgoing packet associated with a particular client application 33 is sent towards the internet by a particular one of mobile devices 40, 42, 44 and 46, the response packet(s) will also be returned by the same one of the mobile devices 40, 42, 44 and 46.

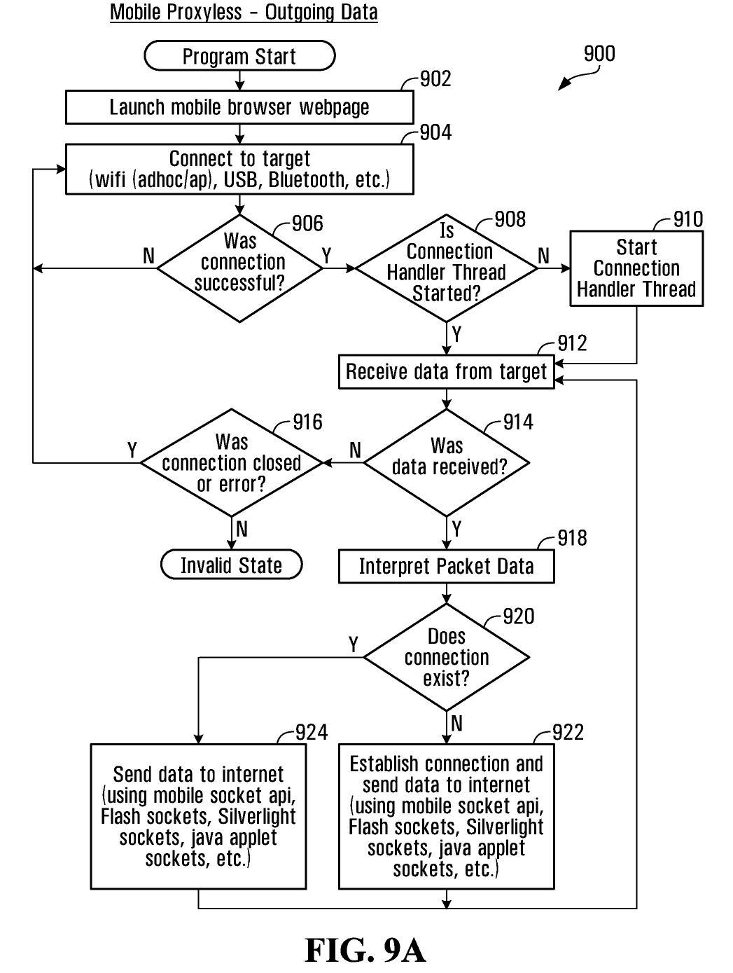

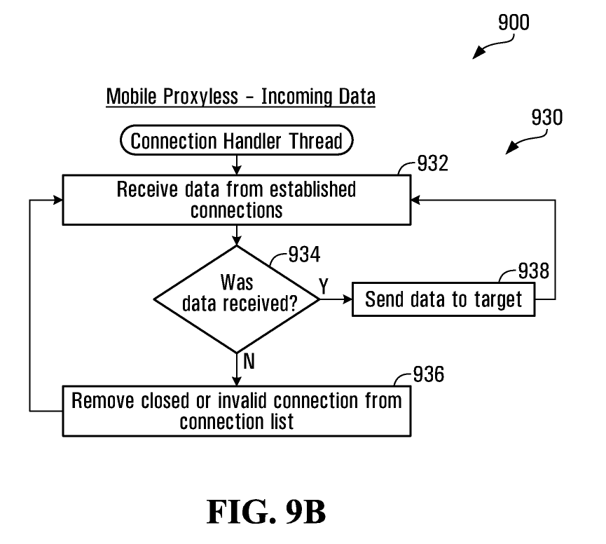

FIGS. 9A and 9B illustrate operation 900 of an exemplary mobile device 40′ for facilitating tethering, with all other mobile devices 42′, 44′ and 46′ operating in a similar manner.

Initially, the mobile browser 46 is instructed to load the browser application 48′ (see FIG. 9A, operation 902) in a similar fashion to the embodiment described above. The mobile browser 46 then opens a data connection (operation 904, FIG. 9A) between the browser application 48′ and the tethering support application 36 executing at the client computing device 30. As before, the manner in which this is done may depend upon the data transport mechanism that is being used over the data connection (e.g. a socket connection over Wi-Fi™, RFCOMM channel over Bluetooth™, proprietary format over USB, etc.). A check is performed as to whether the connection has been successfully received by the client computing device 30 (operation 906, FIG. 9A).

If the data connection was successfully received, then the browser application 48 may engage in a handshaking procedure with the internet server 70. This may be based on the protocol used by the client application, e.g. HTTP if internet explorer requests a webpage, FTP if client application 33 is an FTP client, etc.

If the connection was successful, then the browser application 48′ spawns a thread 930, which may be referred to as the “connection handler thread,” at operation 910. This thread 930, which is illustrated in FIG. 9B, is for receiving incoming (again, from the perspective of the client application 33 on the client computing device 30), internet-originated data and passing it to the tethering support application 36 at the client computing device 30 via any one of the N data connections with mobile devices 40′, 42′, 44′ or 46′. The main logic of the browser application 48′, from operation 912 onward (including possibly branching to 904), handles outgoing, internet-destined data from client computing device 30. In the present embodiment, this logic is not spawned as a separate thread in order to limit overhead for the typically low-power microprocessor and limited memory of the mobile device 40′. To conserve these resources, select/poll/epoll APIs may be preferred. In the present embodiment, thread 930 is spawned only if a check, performed in operation 908, reveals that no such thread is already running.

By operation of the thread 930 and the main logic of the browser application 48′, incoming data can be received from the internet 80 and relayed it to the client computing device 30, and outgoing data can be received from the client computing device 30 and relayed to the internet server 70, respectively. Essentially this allows the mobile browser 46 and browser application 48′ to serve as a bridge in the overall data communications pathway between the client computing device 30 and the internet 80.

Operation of the browser application 48′ for passing data back and forth between the client computing device 30 and the internet 80 differs in certain respects from the operations of threads 530 and 550 (FIGS. 5C and 5D), described above, in view of the lack of an internet proxy server.

In the outgoing direction, data (e.g. the “google.com” HTTP get request) is received from the tethering support application 36 (operation 912, FIG. 9A), over the data connection between the browser application 48′ and the tethering support application 36 and decoded/decompressed as required. If data was not received due to data connection closure or error (operation 916, FIG. 9A), then control returns to operation 904, described above.

Otherwise, the packet data is interpreted to ascertain a destination for the packet (operation 918, FIG. 9A). This may be done by looking up Source/Destination IP/Port in list of existing connections, which may be a network address translation table (e.g. standard Network Address Translation (NAT)), to see if it has already been added to the mapping table. If a connection does not already exist (operation 920, FIG. 9A), a data connection is established and used to send the packet to the internet. The new connection is added to a list of connections maintained by the browser application 48′ which maps client computing device-side connections to internet-side connections. The data connection that is opened by the browser application 48′ in this embodiment is the internet protocol defined in the IP packet, e.g. HTTP, UDP, TCP, ICMP, GRE, etc.

For example, consider the case where the client application 33 wishes to open a connection to google.com on port 80. The browser application 48′ at mobile device 40′ may check the NAT table for a TCP:google.com:80:CLIENTIP:CLIENTPORT (where CLIENT need not necessarily be port 80, but rather can be anything in the 0 to 65535 range that that is not already in use by the O/S 34) mapping and finds no such mapping, meaning no data connection yet exists. As a result, the browser application 48′ connects to google.com on port 80 from MOBILEIP MOBILEPORT using the HTTP protocol (the internet protocol in question in this example) to create the connection, and adds an entry to the NAT table indicative of the mapping TCP:google.com:80:CLIENTIP:CLIENTPORT and MOBILEIP:MOBILEPORT. The MOBILEIP and MOBILEPORT parameters may be known from the socket object used to make the connection, which may contain a reference to these parameters.

Using this data connection, the data is sent to its internet destination (operation 922, FIG. 9A). If the data connection had already existed (operation 920), that data connection would have been used to send the data to its internet destination (operation 924, FIG. 9A).

Operations 920-924 of FIG. 9A are comparable to operations 646-650 of FIG. 6C above, except they are performed at the mobile device 40′ due to the lack of any internet proxy server in the system 800.

In the incoming direction, by operation of thread 930, data (e.g. a portion of the google.com home page response) is received in operation 932 from an established data connection, e.g. from a data connection earlier established in operation 922. If no data is received and the connection has been closed or is no longer valid (operations 934, 936), the data connection is removed from the list of connections, and control returns to operation 932. Otherwise, the data is transmitted to the client computing device 30 (operation 938).

For example, the response packet from google.com may be sent to MOBILEIP MOBILEPORT, which the browser application 48′ looks up and sees this mapping and rewrites to CLIENTIP:CLIENTPORT and fixes the checksums in the packet and sends to the tethering support application 36′.

Unlike the analogous operation at internet proxy server 60 of the system 20 (FIG. 6B, thread 620), there is no need to apportion data to one of N data connections, because there is only one data connection between the mobile device 40′ and the tethering support application 36.

The operation of the browser application 48′ at each of the other mobile devices 42′, 44′ and 46′ is analogous to that of mobile device 40′.

It is also possible to use the tethering architecture of FIGS. 9A and 9B to provide internet access to the client application 33 even when only a single mobile device 40′ is available, such as in system 1000 of FIG. 10. In that case, operation of the browser application 48′ would be the same as described above and illustrated in FIGS. 9A and 9B. The upper limit of upload/download speed and bandwidth of the mobile device 40′ may effectively become the upper limit for speed and bandwidth of the internet connection overall.

In any of systems 20, 800 and 1000, a standalone application could take the place of mobile browser 46 executing browser application 48 or 48′. Although a standalone application may not provide the same benefits as a browser application 48′ in terms of ease of updating and creation of different versions for different platforms, a standalone application may nevertheless be used in some embodiments.

As alluded to above, the client computing device in any of the above-described embodiments is not necessarily the computing device at which the client application requiring access to the internet is executed. For example, the client computing device could be a router. The router may be considered to be “customized” in the sense that, unlike routers that are readily commercially available, the “customized” router is equipped with a tethering support application and a virtual network adapter analogous to those described above in conjunction with FIG. 2 for example. In such embodiments, the client computing device (router) would differ from what is shown in FIG. 2 in that the client application that is the ultimate consumer of internet data would not necessarily be executed on the router. Rather, that client application may be executed on a separate computing device (e.g. laptop computer, tablet computer, or any other type of computing device) in data communication with the router, e.g. via a wireless LAN (e.g. Wi-Fi™) connection (in the case of a wireless router) that may be established in a conventional manner. In other words, the separate computing device executing the client application may connect to such a “customized” router in the same manner as the device would connect to a conventional router. The fact that the mechanism used by the “customized” router to provide internet access differs from the mechanism used by conventional routers may be transparent (i.e. not apparent) to the separate computing device. Data communication between the separate computing device and the router could alternatively be established in other ways, e.g. via Bluetooth™ connection, over a physical cable (e.g. USB connection), or otherwise.

It will further be appreciated that, in some embodiments, the client computing device may be another mobile device, separate from the N mobile devices described above. This mobile device may be referred to as a “master mobile device.” The master mobile device may for example create a Wi-Fi™ hotspot, and the other N mobile devices may connect to the Wi-Fi™ hotspot. The master mobile device may execute a virtual network adapter application and a tethering support application analogous to what is described above for the embodiment of FIG. 1. The tethering support application may vary slightly from what is described above. The variation arises from the fact that, unlike the example client computing devices in the embodiments described above, the client computing device in the present embodiment (i.e. the master mobile device) is itself able to establish a cellular data connection (e.g. a 3G, 4G, EDGE or CDMA data connection) to the internet proxy server (or, more generally, internet server) via a cellular data connection, much in the same way that each of the N mobile devices establishes such a cellular data connection in the earlier described embodiments. This data connection would be in addition to the N cellular data connections formed between the respective N mobile devices and the internet proxy server (i.e. across N+1 cellular data connections). As such, the tethering support application may apportion internet-bound data not only among the N mobile devices to which the client computing device is connected, but also to the client computing device's own cellular data network data connection (or cellular data connection) to the internet proxy server. In the reverse direction, data received over the master mobile device's cellular data connection may be combined with the data received over the N data connections using a similar approach to what described above for combining the data received over just the N data connections. This approach may avoid the need to use a separate piece of equipment (e.g. the customized router), in favor of a mobile device, which are becoming increasingly ubiquitous and which have utility beyond that of a router. In essence, such embodiments can be considered to leverage the fact that a mobile device such as a smartphone typically contains hardware that allows the phone, with proper software, to emulate the “customized” router described above, despite the fact that it is a actually mobile device such as a smartphone.

Processing of internet-bound packets by the tethering support application at a master mobile device may be as follows. For packets apportioned to one of the N mobile devices (i.e. to one of mobile devices that is not the master mobile device), the destination address may be changed to the respective mobile device (e.g. on a Wi-Fi™ network) and sent out of the appropriate adapter on the master mobile device (e.g. a Wi-Fi™ adapter). For packets apportioned to the master mobile device itself, the packet destination may be set to the internet proxy server and sent out via its cellular adapter (e.g. a 3G adapter).

A possible inconvenience that may occur in at least some embodiments employing a master mobile device may be that, in order to be able to install and use a virtual network adapter, it may be necessary, for at least some mobile device platforms, to install a custom kernel module requiring “root access” (essentially, unfettered permissions) to the operating system of the master mobile device. This may be referred to colloquially as “jailbreaking” or “rooting.” For example, provision of a virtual network adapter may require the compiling of the virtual network adapter logic as a module and embedding the module into the operating system kernel. This may be considered risky due to the possibility that a user with unfettered permissions may intentionally or inadvertently render the device inoperable or undesirably access sensitive data.

To avoid the need for such root access, the master mobile device (i.e. the client computing device) may be designed to execute a packet filter, rather than a virtual network adapter, for essentially the same purpose as a virtual network adapter. The packet filter may be designed to use pattern matching to look for specific types of packets or streams and, upon finding a match, to move packets from an original stream to another destination. For example, the packet filter may be configured to analyze the destination address of each IP-based packet that passes through the packet filter and, if the destination address is set to a subnet belonging to the local Wi-Fi™ network, pass the packet through unaltered. Otherwise the packet may be deemed to be an internet-bound packet that should be re-routed to the internet proxy server.

The use of a packet filter may be preferred to a virtual network adapter in some (but not necessarily all) embodiments because a packet filter may be implemented without rooting the device, e.g. by defining the “rules” by which packets are apportioned to multiple connections and then making appropriate API calls to packet filter subsystem functionality in the kernel of the operating system of the master mobile device (e.g. Linux™ devices).

The above-described example embodiment describe the use of a TCP connection (e.g. in conjunction with operations 648 or 650 of FIG. 6C) for sending data between a mobile device and the internet proxy server. In some embodiments, UDP connections may be preferred over TCP connections. The reason may be to avoid a condition colloquially referred to as “TCP meltdown.” TCP meltdown may occur when a base connection starts losing packets in a tunnel connection between the mobile device and the internet proxy server. Packets may be lost if routers/gateways/network devices fail along the path from the mobile device to the proxy server or because the mobile device has gone out of network coverage range, temporarily interrupting communications. Packets could also become stalled by network congestion.

Responsive to the lost packets, a lower layer of the TCP may queue up a retransmission and increase its timeout duration, during which the connection may be blocked. In this case, the upper layer (i.e. payload) TCP may not receive a timely ACK and may also queue a retransmission as a result. If the upper layer timeout is less than timeout of the lower layer, the upper layer may queue up additional retransmissions faster than the lower layer can process them. This may cause the upper layer connection to “stall” as additional retransmissions compound the problem.

In other words, TCP has inherent reliability mechanisms that may cause upper layer retransmissions to be performed when packets are lost. If these occur at a faster rate that they can be processed by a lower layer, then the meltdown problem can result. Such problems may be avoidable if UDP is used instead of TCP, since UDP does not employ the same reliability provisions as TCP. Nevertheless, the choice of TCP versus UDP may be implementation or embodiment-specific, and other factors may influence the choice of which to use.

More generally, it will be appreciated that a possible benefit of using multiple mobile devices, as in FIG. 1, to transmit internet-destined data to the internet, and to transmit internet-originated data back to the client computing device, is that the data will effectively be broken up across multiple cellular data connections. As a result, sniffing of a packet stream on a single cellular data connection would not reveal the entirety of the data being communicated to and/or from the internet. Moreover, even if multiple packet streams could somehow be sniffed, without knowledge of how the data comprising those streams was broken up, it may be difficult to reassemble it into a meaningful whole. This may contribute to or enhance data security, e.g. in comparison to an embodiment employing a single mobile device.

Other modifications will be apparent to those skilled in the art and, therefore, the invention is defined in the claims.

What is claimed is:

1. A method of using a mobile browser on a mobile device to facilitate tethering of a client computing device to the mobile device, the method comprising:
opening a first data connection between a browser application executing in the mobile browser on the mobile device and the client computing device, the first data connection being referred to as a client device data connection;
opening a second data connection between the browser application executing in the mobile browser on the mobile device and an internet server, the second data connection being referred to as an internet server data connection;
using the browser application executing in the mobile browser, automatically relaying internet-destined data received from the client device data connection to the internet server data connection and automatically relaying internet-originated data received from the internet server data connection to the client device data connection.

2. The method of claim 1 wherein the first data connection is a WebSockets data connection and wherein the second data connection is a WebSockets data connection.

3. The method of claim 1 wherein the internet server is an internet proxy server.

4. A method of facilitating tethering of a client computing device to a plurality of mobile devices, the method comprising:
at an internet proxy server having a data connection with each of a plurality of mobile devices, receiving internet-originated data destined for a client application executing either at the client computing device that is tethered to the plurality of mobile devices or at a separate computing device in data communication with the client computing device;
at the internet proxy server, automatically apportioning the internet-originated data among the plurality of data connections for transmission to the plurality of browser applications for relaying to the client computing device.

5. The method of claim 4 wherein the automatic apportioning is performed among the data connections on a round-robin basis or based on determined signal quality of each of a plurality of cellular data connections over which the plurality of data connections are respectively carried.

6. The method of claim 4 wherein the automatic apportioning among the data connections comprises assessing, for each of the plurality of mobile devices with which the plurality of data connections have respectively been made, of an amount of unused data before an operative mobile data plan cap is reached.

7. The method of claim 6 wherein the automatic apportioning apportions more data to a data connection having a large amount of unused data than to a data connection having a small amount of unused data.

8. A method of facilitating tethering of a client computing device to a mobile device, the method comprising:
at a client computing device having a data connection with a browser application executing in a mobile browser of a mobile device, the browser application having opened a data connection for internet connectivity through a cellular data network, transmitting internet-destined data from a client application, the client application executing either at the client computing device or at a separate computing device in data communication with the client computing device, to the browser application via the data connection;
at the client computing device, receiving internet-originated data destined for the client application from the browser application executing in the mobile browser of the mobile device via the data connection.

9. A method of facilitating tethering of a client computing device to a plurality of mobile devices, the method comprising:
at a client computing device having a data connection with each of a plurality of mobile devices each having internet connectivity through a cellular data network, automatically apportioning internet-destined data from a client application, the client application executing either at the client computing device or at a separate computing device in data communication with the client computing device, among the plurality of data connections for transmission to the plurality of mobiles devices;
at the client computing device, receiving internet-originated data destined for the client application from the plurality of data connections with the respective plurality of mobile devices.

10. The method of claim 9 wherein the client computing device is a mobile device having internet connectivity via a cellular data network data connection and wherein the automatically apportioning of the internet-destined data additionally apportions some of the internet-destined data from the client application to the cellular data network data connection of the client computing device.

11. The method of claim 10 further comprising receiving additional internet-originated data, destined for the same client application, from the cellular data network connection of the client computing device and delivering the additional internet-originated data to the client application along with the internet-originated data received from the plurality of data connections.

12. The method of claim 9 wherein the automatic apportioning is performed among the data connections on a round-robin basis or based on a determined quality of the internet connectivity of each of the respective mobile devices.

13. The method of claim 9 wherein the automatic apportioning among the data connections comprises assessing, for each of the plurality of mobile devices with which the plurality of data connections have respectively been made, of an amount of unused data before an operative mobile data plan cap is reached.

14. The method of claim 13 wherein the automatic apportioning apportions more data to a data connection having a large amount of unused data than to a data connection having a small amount of unused data.

15. The method of claim 9 wherein each of the data connections is with a browser application executing in a mobile browser of the respective mobile device, the browser application for relaying the internet-destined data out over the cellular data network and for relaying internet-originated from the cellular data network towards the client application.

16. A method of facilitating tethering of a client computing device to a mobile device over an IEEE 802.11 protocol compliant wireless local area network (WLAN), the method comprising:
at a mobile device having a data connection with a client computing device over an IEEE 802.11 protocol compliant WLAN, the data connection being referred to as a Wi-Fi™ data connection, the Wi-Fi™ data connection having an associated gateway identifier identifying a gateway for accessing the internet via the Wi-Fi™ data connection, the mobile device further having a cellular data network data connection to the internet,
modifying or deleting the gateway identifier identifying the gateway for accessing the internet via the Wi-Fi™ data connection so as to cause the mobile device to use the cellular data network data connection rather than the Wi-Fi™ data connection for relaying internet-destined data from the client computing device.

17. The method of claim 16 wherein the modifying or deleting results in a modified or deleted gateway identifier that indicates that the gateway is unavailable.

18. A method of facilitating tethering of a client computing device to a mobile device over an IEEE 802.11 protocol compliant wireless local area network (WLAN), the method comprising:
at a mobile device having a data connection with a client computing device over an IEEE 802.11 protocol compliant WLAN, the data connection being referred to as a Wi-Fi™ data connection, the mobile device further having a cellular data network data connection to the internet,
upon determining that a destination Internet Protocol (IP) address of an internet-destined IP packet received from the client computing device falls within range of IP destination addresses for which transmission to the internet over the Wi-Fi™ data connection is precluded, using the cellular data network data connection to transmit the internet-destined IP packet towards the internet.

19. The method of claim 18 wherein the range of IP destination addresses for which transmission to the internet over the Wi-Fi™ data connection is precluded is defined using at least one Link-Local Address.

20. A non-transitory machine-readable medium storing instructions that, when executed by a processor of a mobile device, causes the mobile device to effect the method of claim 1.

21. A non-transitory machine-readable medium storing instructions that, when executed by a processor of a mobile device, causes the mobile device to effect the method of claim 16.

22. A mobile device comprising a processor and memory storing instructions that, when executed by the processor, causes the mobile device to effect the method of claim 1.

23. A mobile device comprising a processor and memory storing instructions that, when executed by the processor, causes the mobile device to effect the method of claim 16.

24. A non-transitory machine-readable medium storing instructions that, when executed by a processor of an internet proxy server, causes the internet proxy server to effect the method of claim 4.

25. An internet proxy server comprising a processor and memory storing software that, when executed by the processor, causes the processor to effect the method of claim 4.

26. A non-transitory machine-readable medium storing instructions that, when executed by a processor of a client computing device, effects the method of claim 8.

27. A client computing device comprising a processor and memory storing instructions that, when executed by the processor, causes the processor to effect the method of claim 8.
